(19) United States
(12) Patent Application Publication
(10) Pub. No.: US 2004/0261523 A1
(43) Pub. Date: Dec. 30, 2004

(54) Fluid meter, in particular a water meter with a volumetric measurement chamber

(76) Inventor: Gilles Cognot, Varennes Les Macon (FR)

Correspondence Address: SOFER & HAROUN, L.L.P., Suite 910, 317 Madison Avenue, New York, NY, 10017, US

(21) Appl. No.: 10/817,450

(22) Filed: Apr. 1, 2004

(30) Foreign Application Priority Data
Apr. 4, 2003 (FR) 03 50088

(51) Int. Cl. G01F 15/14

(52) U.S. Cl. 73/273

(57) ABSTRACT

A fluid meter, in particular a water meter, comprises a tank having a bottom and into which is inserted through an opening opposite the bottom in an insertion direction parallel to its axis of symmetry a measurement chamber having at least one orifice connected in a sealed manner to a pipe of the tank via a seal that is adapted to be compressed between an external surface of the chamber and an internal surface of the tank. The seal consists of a bead of polymerizable plastic material deposited onto one of the surfaces.

### BACKGROUND OF THE INVENTION

1. Field of the Invention

The present invention relates to a fluid meter, in particular a water meter with a volumetric measurement chamber.

2. Description of the Prior Art

A prior art meter of this kind comprises a casing or tank having an inlet pipe and an outlet pipe and into which is inserted an oscillating piston type volumetric measurement chamber. The measurement chamber has at least one inlet orifice and at least one outlet orifice. This kind of meter is well known to the person skilled in the art.

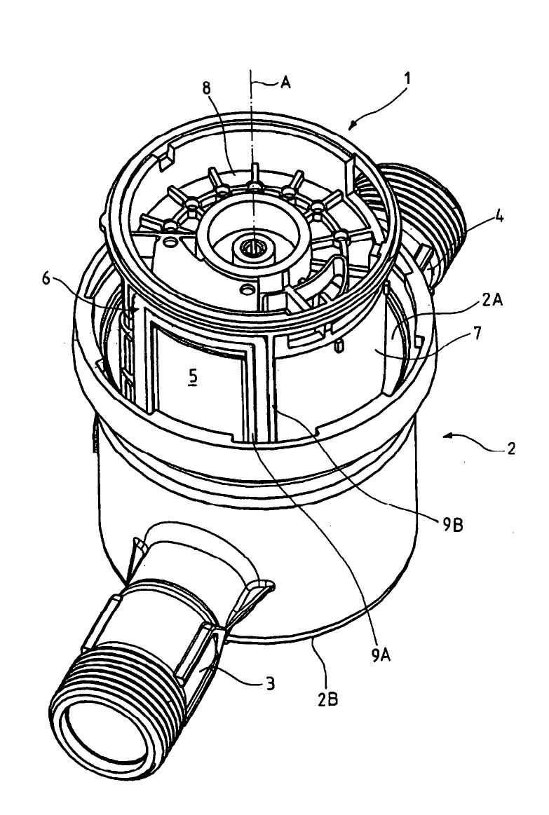

In some forms of measurement chamber, like that shown in FIG. 1, the inlet orifice or the outlet orifice 5 extends over a particular height on the lateral wall of the enclosure of the chamber 1. This orifice must be connected in a sealed manner to the corresponding inlet or outlet pipe 3, 4 and, to this end, a seal 6 is fitted into a groove around the orifice on the external face of the enclosure of the chamber. Once the measurement chamber 1 has been inserted into the tank 2, this seal 6 is compressed in the gap between the measurement chamber and the tank and provides a sealed passage for the fluid between the corresponding pipe and the orifice. The shape of the constant section seal 6 corresponds to that of the orifice, which is generally rectangular.

Assembly is effected by fitting the seal manually into its groove on the measurement chamber 1 and then inserting the measurement chamber into the tank 2.

Generally speaking, in the case of this kind of lateral orifice or in the case of an orifice in the lid or in the bottom of the measurement chamber, this manual fitting of the seal leads to the fabrication of meters that are defective because of incorrect fitting of the seal or even because of the seal being forgotten during assembly.

To be more precise, in the case of a lateral orifice, to provide a seal, the unstressed seal has a diameter greater than the width of the gap between the measurement chamber and the tank. Thus when the measurement chamber, which has a constant generally circular section, is inserted, the seal is subjected to forces in the direction opposite to that in which the measurement chamber is inserted into the tank, which is also of constant circular section, and this applies over the whole of the assembly height. These relatively high forces may expel the seal from the groove, detaching the seal from the measurement chamber, with the risk of deforming the seal in a direction opposite to the insertion direction, and even cutting the seal, the measurement chamber being assembled to the tank with no seal, making the meter useless. These problems are incompatible with mass production assembly of the meter.

### SUMMARY OF THE INVENTION

The invention relates to a fluid meter, in particular a water meter, comprising a tank having a bottom and into which is inserted through an opening opposite the bottom in an insertion direction parallel to its axis of symmetry a measurement chamber having at least one orifice connected in a sealed manner to a pipe of the tank via a seal that is adapted to be compressed between an external surface of the chamber and an internal surface of the tank, wherein the seal consists of a bead of polymerizable plastic material deposited onto one of the surfaces.

Here the pipe 3 is an outlet pipe, and the tank also has an inlet pipe 4. To be more precise, the chamber is inserted via an opening 2A opposite the bottom 2B of the tank. The insertion direction is parallel to the axis A of symmetry of the tank 2.

The external enclosure 7 and the lid 8 of the measurement chamber form an orifice 5 on the lateral wall of the chamber 1 that extends over a particular height and is adapted to be connected in sealed manner to the outlet pipe 3; to this end, a seal is fitted into a groove formed on the external face of the enclosure 7 of the chamber around the orifice 5.

To solve the problems referred to above, the invention proposes that the seal consist of a bead of polymerizable plastic material deposited onto one of said surfaces, and preferably in a groove formed on the measurement chamber. The plastic material is advantageously single-component or two-component silicone.

Thanks to the invention, assembly becomes compatible with mass production assembly quality and productivity constraints. In particular, thanks to the invention, the operation of fitting the seal bead is automated and systematic, in contrast to the prior art, where the seal may be omitted, since it is fitted manually.

In a first embodiment, the bead is deposited before inserting the measurement chamber into the tank.

This embodiment of the seal has the advantage that during application of the bead, which may very easily be automated, the plastic material sticks to the surface onto which it is deposited. This adhesion is such that it allows manipulation of the part, here the measurement chamber, carrying this surface without risk of displacement of the bead.

Most importantly, the measurement chamber may be inserted into the tank as already mentioned above without any risk of the seal being expelled from the groove or being deformed in a direction opposite the insertion direction or being cut.

The measurement chamber may then be inserted into the tank before or after polymerization of the silicone.

The first of these options has the following technical advantages.

Upon insertion of the measurement chamber into the tank, the bead of silicon has a paste-like consistency because it has yet to be polymerized. It may therefore be inserted between the surfaces of these two components without any deforming stress being applied to it.

Upon polymerization of the silicone bead already in place between the measurement chamber and the tank, exactly the same intimate adhesion is created between the bead and each of the surfaces of these components in contact with it. This adhesion is then equalized between the measurement chamber and the tank and no deforming force is created on the measurement chamber in particular that might be harmful through possible consequences in respect of the correct displacement of the oscillating piston. Moreover, this seal arrangement also becomes non-demountable without pulling off the bead.

This assembly method also means that the internal surface of the tank may remain in a raw state, without machining its material, which may be a metal or a plastic material. This is because, for the silicon to stick, there is absolutely no need to have a smooth surface, indeed the opposite is true. This advantage is particularly economical compared to the prior art.

In a variant of this embodiment, an expansion agent may be added to the silicone.

In this case, the expansion agent is chosen so that the bead expands upon polymerization, at which time the measurement chamber is already inserted into the tank. This eliminates all risk of deformation of the bead during insertion.

In a second embodiment, the bead is injected between the surfaces after inserting the measurement chamber into the tank.

In this case, the groove receiving the seal being formed by two ribs 9A, 9B molded onto the exterior enclosure 7 and the lid 8 of the measurement chamber around the orifice 5, the exterior rib 9B on the lid 8 of the measurement chamber is provided with at least one injection orifice through which the silicone is injected into the space delimited by this groove and the surface of the tank.

There is described above an outlet orifice 5 that has to communicate with the outlet pipe 3 of the tank, but the invention applies equally well of course to the situation of an inlet orifice of the same type that has to communicate with the inlet pipe 4 of the tank.

Moreover, in the embodiment described, the seal is mounted in a groove carried by the measurement chamber, but in accordance with the same principle the groove could be carried by the tank.

1. A fluid meter, in particular a water meter, said water meter comprising
a tank having a bottom and into which is inserted through an opening opposite said bottom in an insertion direction parallel to its axis of symmetry a measurement chamber having at least one orifice connected in a sealed manner to a pipe of said tank via a seal that is adapted to be compressed between an external surface of said chamber and an internal surface of said tank, wherein said seal consists of a bead of polymerizable plastic material deposited onto one of said surfaces.

2. The meter claimed in claim 1, wherein said plastic material is silicone.

3. The meter claimed in claim 2, wherein an expansion agent is added to said silicone.

4. The meter claimed in claim 1, wherein said bead is deposited in a groove formed on said measurement chamber.

5. A method of assembling a meter as claimed in claim 1, wherein said bead is deposited before inserting said measurement chamber into said tank.

6. The method claimed in claim 5, wherein said measurement chamber is inserted into said tank before polymerization of said plastic material.

7. The method claimed in claim 6, wherein an expansion step is executed at the time of polymerization.

8. The method claimed in claim 1, wherein said bead is injected between said surfaces after inserting said measurement chamber into said tank.
